(19) United States
(12) Patent Application Publication
(10) Pub. No.: US 2024/0047086 A1
(43) Pub. Date: Feb. 8, 2024

(54) Nuclear fusion reactor technology developed from several nuclear fusion physics hypotheses which extracts fusion heat to generate electricity and enables the fusion device to perform for long periods of time

(71) Applicant: Zachary Charles Crouch, Knoxville, TN (US)

(72) Inventor: Zachary Charles Crouch, Knoxville, TN (US)

(73) Assignee: Zachary Charles Crouch, Knoxville, TN (US)

(21) Appl. No.: 18/221,613

(22) Filed: Jul. 13, 2023

Related U.S. Application Data
(60) Provisional application No. 63/474,308, filed on Aug. 8, 2022.

(51) Int. Cl. G21B 1/05

(52) U.S. Cl. CPC G21B 1/05

(57) ABSTRACT

The pursuit to achieve and maintain net electricity from nuclear fusion devices continues. This invention explores a new method to make this achievement. This advanced nuclear fusion reactor will produce heat continuously and will also be constantly cooled by running water. The plasma temperature of this nuclear fusion reactor will be at least 100,000 Kelvin and no greater than 10,000,000 Kelvin. New hypotheses of physics will point out that electricity from the steam turbine engine will be greater than the energy required to maintain the magnetic confinement. This fusion reactor has a lower temperature and lower magnetic field than many modern fusion reactors but uses new technology to produce more fusion reactions and heat than fusion reactors which use similar temperature and magnetic field strengths. New ideas and new technology should be welcome in a time when global warming evidence is becoming more evident.

### CROSS-REFERENCE TO RELATED APPLICATIONS

Not Applicable.

### STATEMENT REGARDING FEDERALLY SPONSORED RESEARCH OR DEVELOPMENT

There was no federally sponsored research or development which led to the execution of this patent.

### THE NAMES OF THE PARTIES TO A JOINT RESEARCH AGREEMENT

Not Applicable.

### INCORPORATIONS-BY-REFERENCE OF MATERIAL SUBMITTED ON A READ-ONLY OPTICAL DISC OR AS A TEXT FILE VIA THE OFFICE ELECTRONIC FILING SYSTEM (EFS-WEB)

Not Applicable.

### STATEMENT REGARDING PRIOR DISCLOSURES BY THE INVENTOR OR A JOINT INVENTOR

There are no prior disclosures by the inventor with respect to this patent.

### BACKGROUND OF THE INVENTION

### (1) Field of the Invention

This invention relates to energy generation. To be more specific, this invention pertains to nuclear fusion reactors.

### (2) Description of Related Art Including Information Disclosed Under 37 CFR 1.97 and 1.98

(I) Daisaburo Nagata. U.S. Pat. No. 4,689,192A. 1984.
   Nagata invents an electrical insulator of a toroidal nuclear fusion reactor.
(II) John H. Fleet. U.S. Pat. No. 4,172,008A. 1977.
   Fleet invents a nuclear fusion device which collides pulsed ion beams.
(III) Albert G. Fischer. U.S. Pat. No. 4,182,650A. 1973.
   Fischer invents the nuclear fusion of lithium and deuterium by inducing an electrical discharge via a capacitor to produce electricity.

### BRIEF SUMMARY OF THE INVENTION

The invention of this patent pertains to a new type of nuclear fusion reactors which has both similarities and differences from current nuclear fusion reactors. The nuclear fusion reactor shall consist of a tungsten or tungsten carbide inner wall. The nuclear fusion reactor shall consist of a stainless-steel outer wall. The method of confinement shall be magnetic confinement or electrostatic confinement. The coolant shall be water which flows between the inner wall and the outer wall. The method of energy extraction shall be a steam turbine engine. The plasma shall be of a spherical geometry. The nuclear fusion fuel shall be deuterium and tritium. The magnetic field shall be 1 tesla. The volume of the fusion chamber shall be 100 meters cubed. The temperature of the plasma shall be between 100,000 Kelvin and 10,000,000 Kelvin. The density of the plasma shall be between 1 kg/m³ and 10 kg/m³.

### BRIEF DESCRIPTION OF THE SEVERAL VIEWS OF THE DRAWING(S)

FIG. 1: Nuclear Fusion Reactor Prototype Showing the Flow of Water

Legend for Drawing in FIG. 1:

A: Plasma and/or Gas of Fusion Fuel

B: Vacuum or Cooler and Less Dense Plasma and/or Gas of Fusion Fuel

C: Inner Wall

D: Flow of Water Which Enters as Liquid Water and Exits as Steam

Note: While the fusion reactor is not running, this volume can contain air

E: Outer Wall

The arrows represent the flow of water which enters as liquid water and exits as steam. The steam exits the nuclear fusion reactor and generates electricity using a steam turbine engine.

FIG. 2: Nuclear Fusion Reactor Prototype Showing the Insertion of Compressed Fusion Fuel

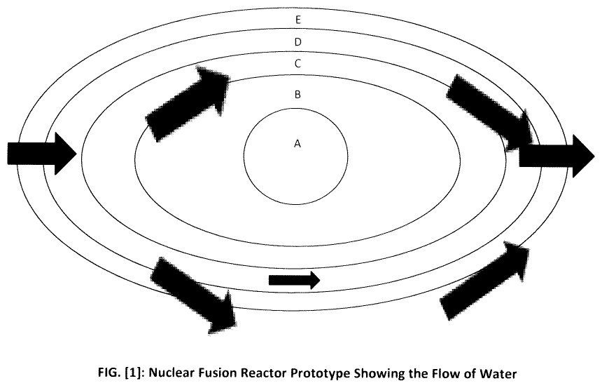

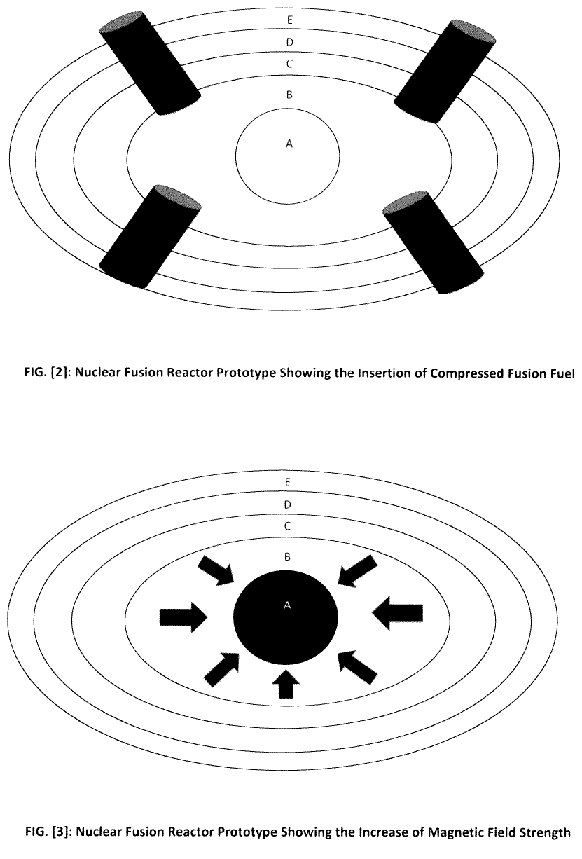

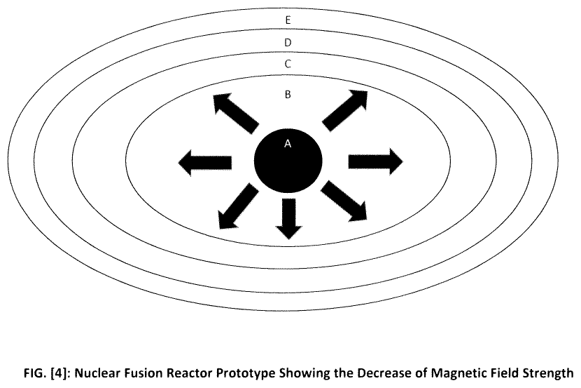

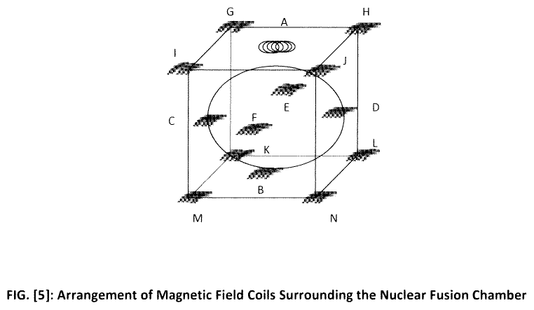

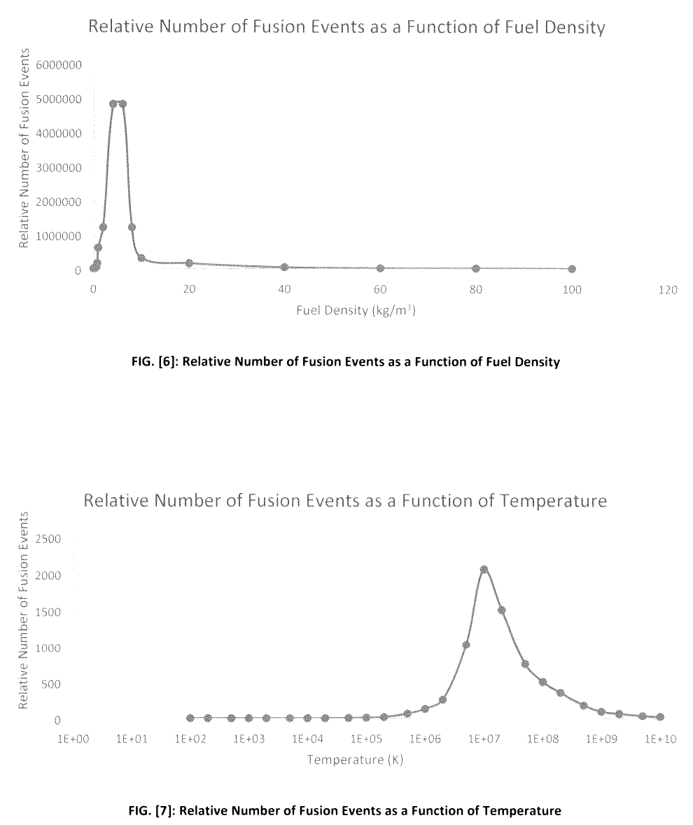

Legend for Drawing in FIG. 2:

A: Plasma and/or Gas of Fusion Fuel

B: Vacuum or Cooler and Less Dense Plasma and/or Gas of Fusion Fuel

C: Inner Wall

D: Flow of Coolant

Note: While the fusion reactor is not running, this volume can contain air

E: Outer Wall

The pipe(s) represent the insertion of compressed fusion fuel to increase the density of the gas in the fusion chamber. Once the fusion chamber reaches a sufficient density of fusion fuel, the pipe(s) move outward, and the inner wall and outer wall both close to keep the gases in the fusion chamber. Note: The 4 pipes shown are not exclusive to claim 2. That is, the number of pipes may be 1 or more.

FIG. 3: Nuclear Fusion Reactor Prototype Showing the Increase of Magnetic Field Strength Legend for Drawing in FIG. 3:

A: Plasma and/or Gas of Fusion Fuel

B: Vacuum or Cooler and Less Dense Plasma and/or Gas of Fusion Fuel

C: Inner Wall

D: Flow of Coolant

Note: While the fusion reactor is not running, this volume can contain air

E: Outer Wall

The arrows represent the increase in magnetic field strength of the magnetic field coils to increase the density of the fusion fuel in the fusion chamber. Once the fusion fuel reaches a relatively high density of fusion fuel, the magnetic field strength of the magnetic field coils will decrease in order to decrease the density of the fusion fuel in the fusion chamber. This is a continuous process.

FIG. 4: Nuclear Fusion Reactor Prototype Showing the Decrease of Magnetic Field Strength

Legend for Drawing in FIG. 4:

A: Plasma and/or Gas of Fusion Fuel

B: Vacuum or Cooler and Less Dense Plasma and/or Gas of Fusion Fuel

C: Inner Wall

D: Flow of Coolant

Note: While the fusion reactor is not running, this volume may contain air

E: Outer Wall

The arrows represent the decrease in magnetic field strength of the magnetic field coils to decrease the density of the fusion fuel in the fusion chamber. Once the fusion fuel reaches a relatively low density of fusion fuel, the magnetic field strength of the magnetic field coils will increase in order to increase the density of the fusion fuel in the fusion chamber. This is a continuous process.

FIG. 5: Arrangement of Magnetic Field Coils Surrounding the Nuclear Fusion Chamber

Legend for Drawing in FIG. 5:

The cube in the drawing is not physical. The cube is shown as a reference to place the magnetic field coils.

The ellipsoid represents the fusion chamber. All magnetic field coils are outside of the fusion chamber.

Magnetic Field Coils A through F represent the magnetic field coils placed at the centers of each of the 6 faces of the cube.

Magnetic Field Coils G through N represent the magnetic field coils placed at the 8 corners of the cube.

FIG. 6: Relative Number of Fusion Events as a Function of Fuel Density

Description for the Graph in FIG. 6 Explained Using Physics:

The fuel density has both advantages and disadvantages for likelihood of a fusion event occurring.

The repulsive forces between fusion nuclei can either push or pull a fusion nucleus toward another fusion nucleus.

Nuclear fusion needs these repulsive forces to maximize the number of fusion events.

There is also overcrowding such that too many nuclear fusion nuclei blockade the fusion events from happening.

On the other hand, insufficient fuel density will decrease the likelihood because there aren't enough fusion nuclei to repulse each other in the right direction.

On the left slope of the graph the fuel density is low, and the lack of repulsive forces make the fusion events less likely.

On the right slope of the graph the fuel density is high, and there exists a blockade of fusion nuclear so that the fusion events are less likely.

There exists a “sweet spot” of fuel density between approximately between 1 kg/m3 and 10 kg/m3 which this patent claims since no other scientists have developed this hypothesis.

FIG. 7: Relative Number of Fusion Events as a Function of Temperature

Description for the Graph in FIG. 7 Explained Using Physics:

In order to achieve nuclear fusion, a temperature above 10,000 Kelvin much be reached to strip the electrons from the atoms.

However, with a higher temperature comes higher velocity of fusion nuclei. The higher velocity is paramount to overcoming the repulsive forces of the positively charged nuclei. Thus, temperatures in the millions of Kelvins are often used to create nuclear fusion events.

The downside to extremely high temperatures is that a nuclear event is likely to occur, but the nuclei do not want to fuse at such high temperatures and velocities. The 2 nuclei often scatter instead of fuse.

Another downside to extremely high temperatures is that they cannot be maintained because it will melt all of its surroundings. Most fusion reactors operate at extremely high temperatures for a few seconds. This is not promising for a net electricity energy system.

The left slope of the graph represents the increase in temperature creating an increase in the velocity of fusion nuclei which will help overcome the repulsive forces of the nuclei. On the left slope, an increase in temperature results in more fusion events.

The right slope of the graph represents the increase in temperature causing an increase in velocity of the fusion nuclei which will cause the nuclei to start to scatter more than fuse. On the right slope, an increase in temperature results in less fusion events.

The system proposed in this patent will lower the temperature to a reasonable amount. This is revolutionary to develop a nuclear fusion reactor at relatively low temperatures.

This patent will claim temperatures in the 100,000 Kelvin to 10,000,000 Kelvin range since this is a revolutionary hypothesis that no other scientists have discovered, and all other nuclear fusion devices operate at or above 100,000,000 Kelvin.

### DETAILED DESCRIPTION OF THE INVENTION.

The classical potential energy, PE, of an object of mass, m, is given by the following equation

PE=mgh

where g is the gravity constant, and h is the height of the object from ground zero.

In a fusion reactor, a magnetic field is used instead of gravity. Thus, M is replaced by g to represent the magnetic field strength. The height is replaced by the radius of the fusion chamber, R, minus the radius of the plasma, r. Now mass is simply the density of the plasma, ρ, multiplied by the volume of the plasma, V.

Then, we have PE=ρVM(R−r)

Volume is simply 4/3πr³ since r denotes the radius of the plasma.

Thus, the equation now becomes PE=4/3πρMr³(R−r)

Which can also be rewritten as PE=4/3πρM(Rr³−r⁴)

The classical kinetic energy, KE, of an object of mass, m, is given by the following equation

KE=½mv²

where v is the average velocity of the mass.

Since velocity is the key factor which increases the rate of nuclear fusion, the internal energy of the plasma must be maximized.

Thus, density must be maximized, the magnetic field must be maximized, the radius of the fusion chamber must be maximized, and the radius of the plasma must be minimized. However, these variables are dependent on one another. When the magnetic field increases, the density of the plasma increases. When the magnetic field increases, the radius of the plasma decreases. R represents the radius of the gas or plasma at ground zero going to standard atmospheric temperature and pressure. R will never be reached so this variable can't be adjusted. However, the potential internal energy of the plasma will be zero if R=r. R will equal r when the radius of the plasma is such that the plasma has a density which is equal to the density of the gas phase at standard temperature and pressure. Thus, there is great importance to have a high density, high magnetic field nuclear fusion reactor.

The ideal gas law is given by the following equation:

PV=nRT

where p is the pressure of the system, v is the volume of the system, n is the number of moles of the gas, R is the ideal gas constant, and T is the temperature of the system.

The internal energy of a gas, E, is given by the following equation:

E= 3/2RT

Combining equations 2 and 4 results is the following relationship:

mv²=3RT

Thus, in an enclosed system, the average velocity of the particles increases as the temperature increases.

This velocity of particles creates a repulsion by other particles to decrease the density because as the particles constantly hit one another, the particles want to be more spread out.

When the density of a plasma increases, the chances of 2 particles colliding each other increases. This is because their neighboring ions exerts force on each other. When enough ions exert forces on an ion, it can overcome the repulsion of one ion with the cumulative forces of other ions. There is also a statistical chance of this occurring because the momentum and direction of this ion (subject to change vastly through its course) must be such that the ion doesn't change its course so as much to redirect itself from colliding into said ion.

However, density is inversely related to temperature in the ideal gas law which can be written as:

P=ρkT

where ρ is the density of the gas and k is Boltzmann's constant.

This inverse relationship hinders the ability of a device to undergo nuclear fusion. As the temperature of the plasma of a nuclear fusion reactor is increased, also is the velocities of the ions and the plasma wants to decrease its density. It will exert an opposing outward force which has to be overcome by magnetic fields, electric fields, gravitational forces, or other forces. Thus, when the temperature of a plasma becomes higher the cost of energy to maintain the plasma in its volume increases.

The Sun has a natural containment mechanism called gravity. The temperature of the plasma is extremely high, and the plasma wants to spread out. However, the Sun's gravity keeps this from occurring and keeps the plasma closer to the Sun. There is not sufficient gravity of Earth for this phenomenon. Thus, on Earth fusion devices utilize magnetic confinement, electrostatic confinement, etc.

The goal of a nuclear fusion device is to produce net electricity continually. When inventing a fusion device, the device must produce a continuous output of electricity. The method of this invention incorporates a continuous flow of heat and power to produce electricity.

An example of nuclear fusion is the deuterium and tritium reaction:

D+T→He+n

where D is a deuterium ion, T is a tritium ion, He is a helium ion, and n is a neutron.

Nuclear fusion consists of a reaction of 2 ions such as deuterium and tritium. Ions have a charge which are highly repelled by electron clouds. Matter which consists of atoms and their electron clouds include gases, liquids, and solids. Thus, nuclear fusion must occur in a plasma since a plasma does not contain electron clouds. Nuclear fission consists of a reaction containing a fissionable element such as uranium or plutonium and a neutron. These neutrons contain no charge and travel through matter easily. Thus, nuclear fission reactions can occur in any state: solids, liquids, gases, and plasmas.

During a nuclear reaction, there is an intermediate phase where the reactants combine. This short-lived phase is called an excited state. This applies to both nuclear fission and nuclear fusion. This excited state demonstrates that both fusion and fission reactions both fuse before they defuse. Further discussion of these excited states will be mentioned in the cross-section section.

The coulomb barrier as pertains to nuclear fusion is the barrier that the ions must overcome to fuse together. Since both fusion ions are positively charged, the ions will repel one another. This coulomb force becomes more intense as the ions become in close vicinity with each other.

To overcome this coulomb barrier, the fusion ions must have the necessary momentum and trajectory. The likelihood of ions overcoming this coulomb barrier increases with increased velocities and densities of the plasma. The collision of ions ultimately depends on the expulsion forces of several nearby ions. High velocities are formed by high temperatures. Thus, most nuclear fusion devices operate at high temperatures. Each ion collision is statistical in nature.

The Sun is extremely hot on its surface, but it is not enclosed. Modern fusion devices want to enclose the plasma as to keep the hot temperature from escaping. The Sun's plasma is also very disordered. There are varying temperatures, velocities, and densities of the plasma ions. Modern fusion devices want to keep an order of these variables. They want to keep temperatures, velocities, and densities equal throughout the plasma. However, keeping the heat in will be problematic when trying to derive its heat for steam generation and power generation. This fusion device invention harnesses the heat at the outside to turn running water into steam. The plasma will be spherical which will contain its highest temperatures in the center of the sphere. The outer edges of the plasma will not be as hot as its center. The tungsten walls will be even more cool as the running water absorbs heat.

The magnetic field exerts a force or pressure, P_{B}, on the plasma by the following relation:

$$P B = \frac{{B}^{2}}{2 μ 0}$$

where B is the magnetic field strength and μ₀ is the magnetic permeability of free space.

When the pressure, P, is equal to the magnetic field pressure, P_{B}, the plasma will remain stable.

Most modern nuclear fusion devices have a magnetic field between 1 Tesla and 12 Tesla.

The magnetic field coils may consist of 6 magnetic field coils which surround the nuclear fusion reactor like the 6 faces of a cube. The magnetic field coils may also consist of 8 magnetic field coils which surround the nuclear fusion reactor like the 8 points of a cube. The magnetic field coils may also consist of 14 magnetic field coils which surround the nuclear fusion reactor like 6 faces of a cube plus 8 points of a cube. Of course, there are many ways that the magnetic field coils may be places around the nuclear fusion reactor.

A gas must reach a temperature of about 0.5 keV or more to transform into a plasma.

Most modern nuclear fusion devices reach temperatures ranging from 10 MeV to 20 MeV.

For comparison reasons, the Sun's surface temperature is about 0.5 keV.

1 keV is equivalent to a temperature of 11,600 Kelvin.

For the nuclear fusion reactor in this invention, any number of typical initial heating mechanisms may be used. These include neutral beam injectors, ion cyclotron resonance, and electron cyclotron resonance heating.

If the volume of the fusion chamber is very large, then the magnetic field will have to be relatively large. This occurs because the magnetic field strength decreases exponentially with the distance between the magnetic field source and the target. Thus, increasing the volume of the fusion chamber will also increase the cost of the input power.

Runaway ions are the fusion fuel ions such as deuterium or tritium ions which escape their regular path with excessive momentum and energy and have great potential to cause a nuclear reaction including nuclear fusion with another fusion fuel ion far from their normal volume. This occurrence is more common in the Sun than in manmade nuclear fusion devices since the fusion ions have a greater range of variables including temperatures, velocities, and densities. Also, these fusion ions are not confined and can roam about in free range unlike manmade fusion devices with keep all variables static and confine nuclear fusion to a given volume. The nuclear fusion reactor in this invention will incorporate on this nuclear fusion physics hypothesis.

Temperature is not the only variable which can increase the velocity of an ion in plasma. A new nuclear fusion physics hypotheses is such that the velocities of ions ultimately increase the chance of fusion. Densities increase the chance that nuclear fusion occurs because there are more fusion fuel ions to interact with. High level densities also create a constant wave-like force between ions which have a net velocity of zero, but each ion has a separate relative velocity between other ions. This internal velocity of ions due to the density of fusion fuel will increase the rate of nuclear fusion. The nuclear fusion reactor design in this invention will utilize this nuclear fusion physics hypothesis with a fusion chamber of high densities of fusion fuel. This nuclear fusion reactor will compress fusion fuel in the fusion chamber up to 200 times the density at standard temperature and pressure via compression tanks. When the density of the fusion fuel is at this density, the holes of the walls will seal to lock the fusion fuel in the fusion chamber.

This nuclear fusion reactor will have a flow of water just outside the inner wall of the fusion chamber such that almost all the heat will be absorbed by the water to make steam. This steam will exit the fusion reactor to generate electricity using a steam turbine engine.

For 2 fusion ions to undergo fusion, the coulomb barrier must be overcome. For the coulomb barrier to be overcome, the fusion ions must have the correct trajectory otherwise the coulomb force will be too large and offset the trajectory such that the ions will not be close enough to undergo nuclear fusion. When the velocity of each ions increases, the chance of a nuclear reaction increases. This is because the momentum of the ions will be greater in comparison to the coulomb force. Each individual nuclear reaction is statistical in nature. However, the overall fusion rate of a large system will be the same for another identical system.

High velocities of the fusion ions increase the rate of nuclear reactions, but do not necessarily increase the rate of nuclear fusion. A nuclear reaction of 2 fusion ions has another choice: to undergo a scatter instead. During nuclear fusion, the excited state of the nucleus needs to be able to absorb kinetic energy of the fusion ions. When the velocities of the fusion ions are extremely large, there is a greater chance that the fusion ions will undergo scattering instead of nuclear fusion. This new nuclear fusion physics hypothesis will be utilized in the design of the nuclear fusion reactor in this invention. Since a moderate velocity is desired to lower the cost of the magnetic field and lower the ratio of scattering reactions to fusion reactions, the temperature of this nuclear fusion reactor will also be moderate.

Most scientists agree that higher temperatures will increase the rate of nuclear fusion. This is correct in a sense. However, a new nuclear fusion physics hypothesis is such that the temperature increases the velocity of ions but decreases the nuclear fusion cross-sections of the fusion ions. It would be extremely difficult to test this hypothesis since the cross-sections are based on nuclear fusion experiments. These experiments use fusion ions which have positive charges and must overcome the coulomb barrier. If these experiments test the cross-sections in a large-scale fusion device, then there is already the velocity factor which would deem the results inaccurate. If there was a small-scale experiment of one deuterium ion and one tritium ion accelerating in an accelerator, the nuclear fusion cross-section would be more accurate, but the extreme velocity of the ions would cause the temperatures to increase. Thus, these results would also be inaccurate since an extremely large velocity would be necessary to overcome the coulomb barrier and the ions would pick up frictional heat by tiny particles in the accelerator. During nuclear fission, there is no coulomb barrier to overcome since neutrons have no charge. These nuclear fission cross-sections increase with decreasing temperature. Nuclear fusion and nuclear fission are quite similar because both reactions create an excited state then break apart to create the lowest nuclear energy state. The design in this nuclear fusion reactor will utilize this nuclear fusion physics hypothesis by using a moderate temperature to keep nuclear fusion cross-sections high.

Another new nuclear fusion physics hypothesis is hot-cold fusion. Hot-cold fusion would consist of a plasma of a hot plasma of fusion fuel combining with a plasma of cold plasma to create more nuclear fusion events. The reason to combine a hot plasma with a cold plasma would be to combine the high velocity of the hot plasma with the large nuclear fusion cross-sections of the cold plasma. This may have the ability to create more nuclear fusion events. The Sun may be utilizing this new nuclear fusion physics hypothesis since the outer edges of the Sun undergo greater cooling than the inner edges of the Sun. The design of the nuclear fusion reactor in this invention will utilize this hypothesis to a small extent by having a large temperature gradient from the center of the fusion fuel in the chamber to the cold walls of the fusion chamber. The cooling of the walls is performed by a constant flow of water which will used to generate electricity. Thus, negligible losses of energy will occur by keeping the walls of the fusion chamber cool.

The fusion ions of a nuclear fusion reactor are moving with high velocities. However, high velocities are irrelevant if the fusion ions are all moving in the same velocity with the same trajectory. The relative velocity of a fusion ion with respect to another fusion ion is what matters. In modern nuclear fusion reactors, equilibrium will occur when the system has met a specified pressure, density, temperature, etc. This equilibrium will cause all the fusion anions and cations to “line up”. This lining up of the cations and anions makes it difficult for a fusion ion to cross into a realm of another fusion ion. In order to force the fusion ions to cross over their natural path, the nuclear reactor core will have to come out of its equilibrium. The changing of this equilibrium will have to happen continually. One method of continually changing this equilibrium is by continually increasing and decreasing the pressure of the fusion ions. Changing the pressure of the fusion ions will also change density and temperature. To change the pressure of the fusion ions, the magnetic pressure of the nuclear fusion reactor must all continually be increased and decreased. To change the magnetic pressure of the fusion reactor, the magnetic field coils must vary their magnetic fields continually. To vary the magnetic field strength continually, the magnetic field coils must lower or raise their magnetic field strength. Another way to vary the magnetic field strength is to continually vary the distance of the magnetic field coils with respect to the nuclear fusion reactor core. This nuclear fusion reactor proposes magnetic field coils which continually increase and decrease the magnetic field strength. This method will force the fusion ions to cross their natural path to several other fusion ions which will increase fusion rates.

In summary, this nuclear fusion reactor utilizes many new nuclear fusion physics hypotheses. The high-density hypotheses spread throughout the patent description contain multiple new nuclear fusion physics hypotheses which are taken in consideration by increasing the density of the plasma. This nuclear fusion reactor will incorporate the new nuclear fusion physics hypothesis of scattering cross-sections previously explained by maximizing the temperature to 10,000,000 Kelvin. This nuclear fusion reactor utilizes the hot-cold fusion theory by maintaining a high temperature gradient across the reactor. This temperature gradient will range from less than 3,000 Kelvin at the wall of the fusion chamber to up to 10,000,000 Kelvin at the center of the plasma.

This nuclear fusion reactor still maintains unprecedented practicality in running for long periods of time while maintaining the utilization of these new nuclear fusion physics hypotheses. The running water serves multiple purposes: to cool the wall of the fusion chamber so the wall will not melt, to heat the water to produce steam to run a steam turbine engine, and to moderate the neutrons from the nuclear fusion reactions. These neutrons may also be captured to recycle nuclear fusion fuel. The low temperature of the plasma will allow the nuclear fusion reactor to run for long durations. The nuclear fusion reactor will be constantly running, constantly cooled, and the rate of loss of heat from the plasma will be continuous. This nuclear fusion reactor strives to turn all the heat losses of the plasma into electricity. This is achieved by allowing the water to completely surround and flow on the wall of the fusion chamber. The temperature of the plasma will still be above 100,000 Kelvin so that the nuclear fusion reactions can maximize fusion rates via creating high velocities through this minimal temperature. Through the practicality of this invention and the multiple new nuclear fusion physics hypotheses it incorporates, there is a great chance that this device will produce net electricity.

1: A flow of water which travels on the outside of the inner wall which is between previously mentioned flow of water and a plasma of fusion fuel which undergoes nuclear fusion wherein:
water has the ability of absorbing heat of the nuclear fusion device to run a steam turbine engine, and
water is capable of moving in a continuous path around the wall, enters on one end as water, and exits on another end as steam.

2: An insertion of fusion fuel by compressed gas into the fusion chamber to increase the density of the fusion fuel wherein:
fusion fuel may consist of deuterium, tritium, helium-3, lithium-6, hydrogen, or boron-11, and
after the fusion fuel inside the fusion chamber reaches sufficient density, the holes in the inner wall and outer wall of the fusion reactor close to keep the gas enclosed.

3: Nuclear fusion fuel plasma(s) in the nuclear fusion chamber of a nuclear fusion reactor wherein:
fusion fuel plasma(s) may consist of protons, deuterons, tritons, helium ions, or helium-3 ions, and
the temperature of the fusion fuel plasma(s) operates continuously between 100,000 Kelvin and 10,000,000 Kelvin.

4: Nuclear fusion fuel gases and/or plasma(s) of nuclear fusion fuel in the nuclear fusion chamber of a nuclear fusion reactor wherein:
fusion fuel gases may consist of hydrogen, deuterium, tritium, helium, or helium-3,
fusion fuel plasma(s) may consist of protons, deuterons, tritons, helium ions, or helium-3 ions, and
the density of these gases or plasma(s) is between 1 kg/m³ and 10 kg/m³.

5: The arrangement of magnetic field coils of a nuclear fusion reactor such that there are 14 separate magnetic field coils wherein:
6 of the magnetic field coils are arranged equidistant from the center of the fusion chamber like 6 faces of a cube even though the fusion chamber may not be physically a cube, and
8 of the magnetic field coils are arranged equidistant from the center of the fusion chamber like 8 points of a cube even though the fusion chamber may not be physically a cube.

6: Magnetic field coils of a nuclear fusion reactor wherein:
the magnetic field coils continually change their distance with respect to the nuclear fusion core, or
the magnetic field coils alternate their magnetic field strength by electric or other means, or
the magnetic field coils continually change their distance with respect to the nuclear fusion core and the magnetic fields alternate their magnetic field strength by electric or other means.
